(19) United States
(12) Patent Application Publication
(10) Pub. No.: US 2014/0323177 A1
(43) Pub. Date: Oct. 30, 2014

(54) Apparatus and Method of Discontinuous Operation in LTE on Shared Band

(71) Applicants: Wei Zou, Shanghai (CN); Timo Koskela, Oulu (FI); Samuli Turtinen, Ii (FI); Sami-Jukka Hakola, Kempele (FI)

(72) Inventors: Wei Zou, Shanghai (CN); Timo Koskela, Oulu (FI); Samuli Turtinen, Ii (FI); Sami-Jukka Hakola, Kempele (FI)

(73) Assignee: Broadcome Corporation, Irvine, CA (US)

(21) Appl. No.: 14/363,509

(22) PCT Filed: Dec. 9, 2011
(86) PCT No.: PCT/CN2011/083746

§ 371 Date: Jun. 11, 2014

(51) Int. Cl. H04W 76/04

(52) U.S. Cl. CPC H04W 76/048
USPC 455/550.1

(57) ABSTRACT

An apparatus and a method is proposed, by which transmission operation is performed during a transmission on period and transmission operation is suspended during a transmission off period, wherein counting of at least one transmission related timer is suspended during the transmission off period.

### FIELD OF THE INVENTION

The present invention relates to methods, devices and computer program products for supporting a discontinuous operation on a shared band, for example in LTE.

### BACKGROUND

The following meanings for the abbreviations used in this specification apply:

ARQ Automatic Repeat Request

DO Discontinuous operation

DRX Discontinuous Reception

eNB Evolved Node B

HARQ Hybrid ARQ

ISM Industrial, Scientific and Medical

LTE Long Term Evolution

LTE-A Long Term Evolution Advanced

MAC Medium Access Control

PHY Physical Layer

RAT Radio Access Technology

RLC Radio Link Control

RRC Radio Resource Control

TDM Time Division Multiplex

TVWS TV White Spaces

UE User Equipment

WLAN Wireless Local Area Network

The increased spectrum requirements due to the increased data traffic drives operators seek offloading solutions for their traffic via local nodes providing local access to the Internet. However, that approach and solutions to improve spectrum efficiency cannot support the predicted data traffic in the future. Thus, operators, network and device manufacturers and other players in the field are considering the utilization of shared spectrum, such as ISM bands and TV white spaces, so that the traffic can be delivered without costly license fee.

From LTE evolution perspective, attractive solutions on shared bands could be licensed spectrum controlled or even stand-alone LTE-A femto cells providing fast access to the Internet in similar manner to WLAN specified in IEEE 802.11, However, LTE's flexibility to manage deployment bandwidth, number of utilized carriers, and the centralized multiuser scheduling offer tempting possibilities over IEEE 802.11 standards.

In the shared band communication, such as ISM or TVWS, the channels are between multiple users, even multiple RATs. In one, more specific case, multiple LTE-femto cells may share a channel e.g. due to the heavy load in the other shared channels. On the other hand specific systems may operate on specific shared channels; such case may occur e.g. on TVWS where a central coordination element e.g. coexistence manager assigns same RATs to the same channel. Similar situation may also occur on ISM band. In this case, where multiple LTE-femto cells share the same channel in TDM way they occupy the channel in specific time slots and defer access in others. As a result, that LTE femto cell operates in discontinuous time slots, as shown in FIG. 2. The ‘ON’ period is the working period of a femto cell and ‘OFF’ period is the period when the cell needs to leave the channel empty.

Such kind of discontinuous operation (DO) mode differs from traditional LTE scenario where an eNB operates a cell on the channel in continuous manner. Although DO mode can support coexistence between femto cells by time-domain channel sharing, it also brings a problem. In LTE system, there are many timers controlling the operations from PHY layer to RRC layer at both UE side and eNB side. If these timers still run as same as before without considering the existence of ‘OFF’ periods, the system will experience problems since during “OFF” periods the timers are still running but there is no possibility to transmit data to reset certain timers. Also, even when a timer expires, the related signaling transmissions have to wait until the next ‘ON’ period. For example, due to the “OFF” periods in the DO mode, HARQ transmission acknowledgement has to wait until the next “ON” period before it can be sent. Hence, round-trip delay in the HARQ process becomes much larger. Also, retransmission delay may also become so large that some timers in upper levels (for example at the RLC layer) may expire.

For the protocol layer timers it should be differentiated when the expiration happens due to bad channel conditions and too many users in the system rather than due to the limited channel access.

Traditional LTE/LTE-A protocol does not consider such kind of problems caused by DO mode. Examples for MAC layer timers are given in 3GPP 36.321 Medium Access Control (MAC) protocol specification, and examples for RLC timers are given in 3GPP 36.322: Radio Link Control (RLC) protocol specification.

### SUMMARY

The present invention addresses such situation and proposes in exemplary embodiments new solutions for supporting discontinuous operation in a mobile network system, such as an LTE system, for example.

Various aspects of examples of the invention are set out in the claims.

According to a first aspect of embodiments of the present invention, there is provided an apparatus which comprises a processor, and at least one transmission related timer, wherein the processor is configured to perform transmission operation during a transmission on period and suspend transmission operation during a transmission off period, and the processor is configured to suspend counting of the at least one transmission related timer during the transmission off period.

According to a second aspect of embodiments of the present invention, there is provided a method which comprises:
performing transmission operation during a transmission on period and suspending transmission operation during a transmission off period, and
suspending counting of at least one transmission related timer during the transmission off period.

According to a third aspect of embodiments of the present invention, there is provided an apparatus comprising
a processor configured to establish a discontinuous operation configuration message by which a transmission on period and/or transmission off period is configured, by which counting of at least one transmission related timer in a network element during the off period is suspended, and
an interface configured to send the discontinuous operation configuration message to the network element.

According to a fourth aspect of embodiments of the present invention, there is provided a method which comprises:
establishing a discontinuous operation configuration message by which a transmission on period and/or transmission off period is configured, by which counting of at least one transmission related timer in a network element during the off period is suspended, and
sending the discontinuous operation configuration message to the network element.

According to a fifth aspect of embodiments of the present invention, there is provided a computer program product comprising computer-executable components which, when executed on a computer, are configured to carry out the method as defined in the above second and fourths aspects and variations thereof.

Thus, according to embodiments of the present invention, a transmission related timer (e.g., an LTE timer) is suspended during the transmission off period, e.g., it holds its count value present at the beginning of the transmission off period (i.e., at the end of the transmission on period) until the end of the transmission off period unchanged.

Hence, discontinuous operation can be reliably provided.

### BRIEF DESCRIPTION OF DRAWINGS

For a more complete understanding of example embodiments of the present invention, reference is now made to the following descriptions taken in connection with the accompanying drawings in which:

FIG. 1 schematically illustrates a network element to an embodiment of the present invention,

FIG. 2 illustrates a discontinuous transmission operation mode in a shared-band,

FIG. 3 illustrates virtual continuous transmission discontinuous transmission operation mode according to an embodiment of the present invention,

FIG. 4 shows control relations between timers at UE side according to an embodiment of the present invention, and

FIG. 5 schematically illustrates a network control element according to an embodiment of the present invention.

### DESCRIPTION OF EXEMPLARY EMBODIMENTS

Exemplary aspects of the invention will be described herein below.

It is to be noted that the following exemplary description refers to an environment of the LTE system (long term evolution) and/or local area networks thereof. However, it is to be understood that this serves for explanatory purposes only. Other systems differing from the LTE system can be adopted.

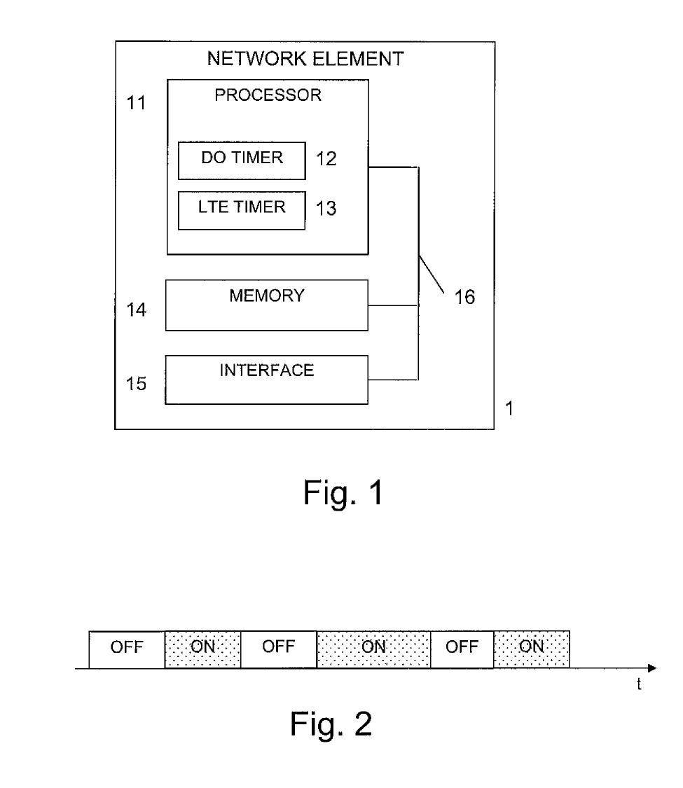

FIG. 1 illustrates a simplified block diagram of a network element 1, which may be a user equipment (UE) or an eNB, for example. It is noted that apparatus according to the embodiment may consist only of parts of this network element, so that the apparatus may be installed in an UE or an eNB, for example.

The network element 1 according to this embodiment comprises a processor 11 and a LTE timer 13 as an example for a transmission related timer. The processor is configured to perform transmission operation during a transmission on period and to suspend transmission operation during a transmission off period, and to suspend counting of the at least one transmission related timer during the transmission off period.

The processor 11 may also comprise a discontinuous operation (DO) timer 12 as an example for a master timer, which counts the transmission on period and the transmission off period.

Optionally, the network element 1 may also comprise a memory 14, which may comprise a computer program for controlling the processor.

Furthermore, the network element 1 may also comprise an interface 15 for providing connections to other network elements. The processor 11, the memory 14 and the interface 15 may be inter-connected by a suitable connection 16, e.g., a bus or the like. Moreover, it is noted that the apparatus may comprise more than one processor, more than one DO timer, more than one LTE timer, more than one memory and/or more than one interface, if this is suitable for a particular structure.

Furthermore, in FIG. 1, the timers are shown as integrated in the processor. However, the processor and the timers may also be separate elements.

Thus, by embodiments of the invention as described above, the LTE timers are allowed to count only during the on period of the DO timer. That is, according to embodiments, a solution for the timer problem caused by discontinuous operation (DO) is achieved.

Examples for LTE timers concerned are mac-ContentionResolutionTimer, drx-InactivityTimer, drx-RetransmissionTimer, drxShortCycleTimer, HARQ RTT Timer etc. as defined in 3GPP TS 36.321-V10.3.0, and t-PollRetransmit, t-Reordering, t-StatusProhibit etc. as defined 3GPP TS 36.322 V10.0.0.

In the following, some more detailed examples for embodiments of the present invention are described.

In detail, according to one embodiment a DOConfiguration message is proposed to be broadcasted from the eNB, where the eNB's ‘ON’ periods (as an example for the transmission on periods) are indicated.

In one embodiment, one or several new-defined timers, e.g., referred to as DO-ON timer, DO-OFF timer etc., are introduced to UE's function block. The UE will configure the aforementioned timers by means of the received DOConfiguration message, and use them as the top-level controller of the configured timers in LTE protocols to realize virtual continuous operation without changing the original LTE configurations of all timers.

In this way, on the network side (e.g., in an eNB) the specific Femto cell timers are stopped during OFF periods. On the UE side, the specific UE timers are stopped during OFF periods.

Thus, according to certain embodiments of the present invention, in order to solve the problems caused by discontinuous operation (DO), it is proposed that eNB broadcast the new-defined DOConfiguration message, where the ‘ON’ periods are indicated. This message can be broadcasted on the shared operating channel in the ‘ON’ period periodically, for instance in System Information Block 2 to be read by both RRC_IDLE and RRC_CONNECTED devices.

After a UE receives the DOConfiguration message, it will use the information in that message to configure its DO timers. According to the present embodiment, it is proposed to use two new-defined timers for the top-level control of all the other timers in LTE protocols: DO-ON timer and DO-OFF timer. The DO-ON timer will be reset at the beginning of each ‘ON’ period and expire at the end of ‘ON’ period. The DO-OFF timer will be reset at the beginning of each ‘OFF’ period and expire at the end of the ‘OFF’ period. Only when DO-ON timer does not expire, other LTE timers can be running. Otherwise, DO-OFF timer will be running, and the configured other LTE timers will stop running (the cell may configure which timers are affected by the ON-OFF periods). Thus, during OFF periods, the LTE cell gets into the so-called ‘frozen’ state, that is, basically at least the transmission related operation of the LTE cell is suspended during the OFF periods.

That is, the LTE cell will become ‘frozen’ at each ‘OFF’ period, and continue its operation again at each ‘ON’ period.

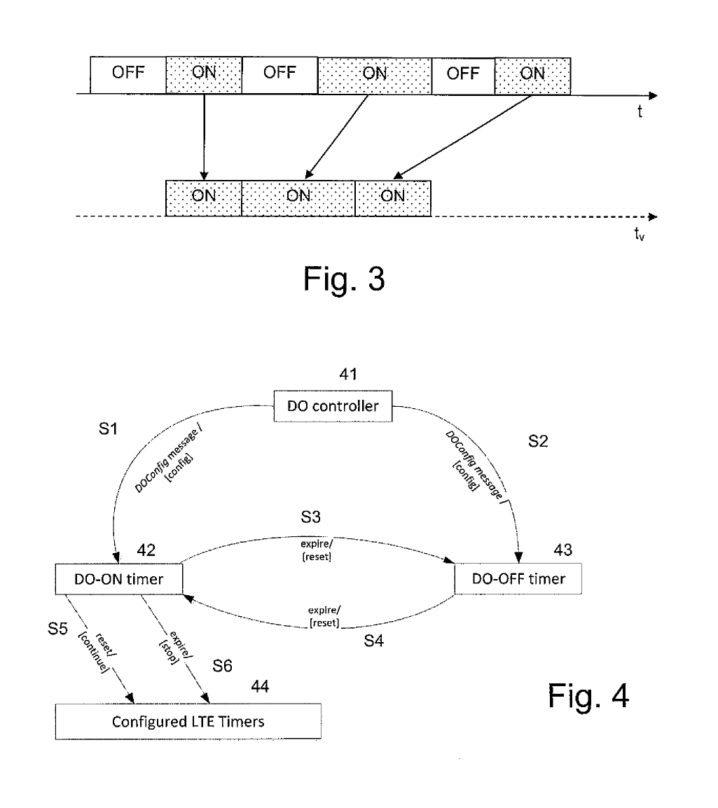

As a result, a virtual continuous operation can be realized, as shown in FIG. 3. Such kind of virtual continuous operation can simplify the configuration of LTE timers because all LTE timers now can be configured as same as in the traditional LTE case.

The detailed control relations of different timers at UE side are shown in FIG. 4. In detail, FIG. 4 shows the relations between a DO controller 41 (which may be a corresponding function in the processor 11 shown in FIG. 1), a DO-ON timer 42 and a DO-OFF timer 43 (which may together constitute the DO timer 12 shown in FIG. 1), and configured LTE timers 44 (which may correspond to the LTE timer 13 shown in FIG. 1).

The control relations are indicated by messages between the elements shown in FIG. 4, wherein the first-line text along with each dashed line describes the trigger signal of the action specified in the following bracket.

When a UE receives a DOConfiguration message, the DO controller 41 will configure the initial value and the starting time of DO-ON and DO-OFF timers 42 and 43 (as indicated by the DOConfiguration/[config] message). After that, the DO-ON timer 42 and the DO-OFF timer 43 will start their running and mutual control. When the DO-ON timer expires, it will reset the DO-OFF timer 43 (as indicated by the expire/[reset] message). Also, the DO-ON timer 42 will be reset when DO-OFF timer 43 expires (as indicated by the expire/[reset] message). All other LTE timers will stop if DO-ON timer 42 expires (as indicated by the expire/[stop] message in S6) and will continue their operation after the DO-ON timer 42 resets (as indicated by the reset/[continue] message in S5).

According to a more general embodiment, a method comprises performing transmission operation during a transmission on period and suspending transmission operation during a transmission off period, and suspending counting of at least one transmission related timer during the transmission off period. Sending of the message in S6 shown in FIG. 4 is an example for the above suspending process.

Thus, according to the embodiments described above, it is possible to support DO mode and channel sharing between different LTE femto cells.

Furthermore, there is only a small impact to traditional LTE protocol, and all LTE timers can be configured as before.

Moreover, a simple implementation of the control by DO timers is possible.

The invention is not limited to the embodiments described above, and various modifications are possible.

For example, in the above embodiments, the case was described that the DOConfiguration message is established by an eNB to which the UE is connected. However, it is also possible that another suitable network control element establishes the DOConfiguration message.

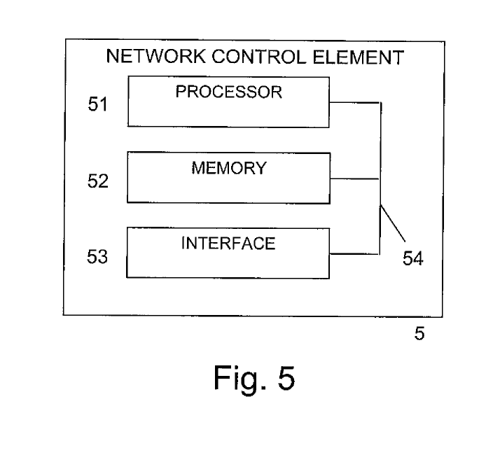

An example for such a network control element is shown in FIG. 5.

The network control element 5 according to this embodiment comprises a processor 51 and an interface 53. The processor is configured establish a DOConfiguration message (as an example for a discontinuous operation configuration message) by which a transmission on period and/or transmission off period is configured, by which counting of at least one transmission related timer in a network element during the off period is suspended. The interface 53 is configured to send the discontinuous operation configuration message to the network element.

The network element, to which the DOConfiguration message is sent, may be a UE and/or an eNB, for example.

The network control element 5 may also comprise a memory 52, which may comprise a computer program for controlling the processor 51. The processor 51, the memory 52 and the interface 53 may be inter-connected by a suitable connection 54, e.g., a bus or the like. Moreover, similar as in case of FIG. 1, it is noted that the apparatus may comprise more than one processor, more than one memory and/or more than one interface, if this is suitable for a particular structure.

According to the embodiments above, the master timer is implemented as a single DO timer (e.g., DO timer 12 shown in FIG. 1) or by two timers (e.g., DO-ON timer 42 and DO-OFF timer 43 shown in FIG. 4). However, the master timer can be implemented also in form of more timers, as long as it can count the corresponding on and off periods.

Furthermore, it is noted that the on and off periods may not be regularly. That is, the length of the on and off periods may change as required, wherein such a change may be indicated to the network elements by the configuration message. That is, with respect to the example shown in FIG. 4, each time the DO controller 41 receives a new DOConfiguration message, the on and off periods of the DO-ON and DO-OFF timers 42 and 43 are newly set.

Moreover, in the above embodiments it was described that the DOConfiguration message is broadcasted on a corresponding channel. However, the invention is not limited to this, and the DOConfiguration message may be directly sent to a network element on a dedicated channel (e.g., from eNB to UE).

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular, but without limitation, to mobile communications, for example to environments under LTE, WCDMA, WIMAX and WLAN and can advantageously be implemented in user equipments or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

Thus, according to several aspects of embodiments of the present invention, an apparatus and a method are provided, by which transmission operation is performed during a transmission on period and transmission operation is suspended during a transmission off period, wherein counting of at least one transmission related timer is suspended during the transmission off period.

According to a further aspect of several embodiments of the present invention, an apparatus is provided which comprises
means for performing transmission operation during a transmission on period and for suspending transmission operation during a transmission off period, and
means for suspending counting of at least one transmission related timer during the transmission off period.

According to another aspect of several embodiments of the present invention, an apparatus is provided which comprises
means for establishing a discontinuous operation configuration message by which a transmission on period and/or transmission off period is configured, by which counting of at least one transmission related timer in a network element during the off period is suspended, and
means for sending the discontinuous operation configuration message to the network element.

Variations of the above aspects may be similar to those described in the dependent claims.

It is to be understood that any of the above modifications can be applied singly or in combination to the respective aspects and/or embodiments to which they refer, unless they are explicitly stated as excluding alternatives.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising
at least one processor,
at least one memory including a set of computer instructions, and
at least one transmission related timer,
the at least one memory and the computer instructions configured, with the at least one processor, to cause the apparatus to at least:
perform transmission operation during a transmission on period and suspend transmission operation during a transmission off period, and
suspend counting of the at least one transmission related timer during the transmission off period.

2. The apparatus according to claim 1, wherein the at least one memory and the computer instructions are configured, with the at least one processor, to cause the apparatus to at least
allow counting of the at least one transmission related timer during the transmission on period.

3. The apparatus according to claim 1, wherein the apparatus
comprises a master timer configured to count the transmission on period and the transmission off period.

4. The apparatus according to claim 3, wherein
the master timer comprises an on timer configured to count the transmission on period and an off timer configured to count the transmission off period.

5. The apparatus according to claim 4, wherein
the on timer is configured to reset the off timer at the end of the transmission off period and
the off timer is configured to reset the on timer at the end of the transmission on period.

6. The apparatus according to claim 3, wherein
the master timer is configured to suspend counting of the at least one transmission related timer during the transmission off period by commanding the at least one transmission related timer to stop counting and to hold a count value present at the end of the transmission on period until the end of the transmission off period unchanged.

7. The apparatus according to claim 1, wherein the memory and the computer instructions are configured with the processor to cause the apparatus to
receive a discontinuous operation configuration message by which the transmission on period and/or transmission off period is configured.

8. The apparatus according to claim 7, wherein
the discontinuous operation configuration message is received on a shared operation channel during the transmission on period.

9. The apparatus according to claim 7, wherein
the discontinuous operation configuration message is received during an operation state and during an idle state.

10. The apparatus according to claim 1, wherein the memory and the computer instructions are configured with the processor to cause the apparatus to
configure a discontinuous operation configuration message by which the on period and/or off period is configured and to send the discontinuous operation configuration message to a network element.

11. An apparatus comprising
at least one processor, and
at least one memory including a set of computer instructions,
the at least one memory and the computer instructions configured, with the at least one processor, to cause the apparatus to at least:
establish a discontinuous operation configuration message by which a transmission on period and/or transmission off period is configured, by which counting of at least one transmission related timer in a network element during the off period is suspended, and
to send the discontinuous operation configuration message to the network element.

12. The apparatus according to claim 10, wherein
the discontinuous operation configuration message is sent on a shared operation channel during the transmission on period.

13. The apparatus according to claim 11, wherein
the discontinuous operation configuration message is sent during an operation state and during an idle state of a network element to which the discontinuous operation configuration message is to be sent.

14. A method comprising
performing transmission operation during a transmission on period and suspending transmission operation during a transmission off period, and
suspending counting of at least one transmission related timer during the transmission off period.

15. The method according to claim 14, further comprising
allowing counting of the at least one transmission related timer during the transmission on period, wherein counting of the transmission on period and the transmission off period is performed by a master timer.

16. (canceled)

17. The method according to claim 15, wherein
the master timer comprises an on timer counting the transmission on period and an off timer counting the transmission off period, wherein the on timer resets the off timer at the end of the transmission off period, and the off timer resets the on timer at the end of the transmission on period.

18. (canceled)

19. The method according to claim 14, wherein
suspending counting of the at least one transmission related timer during the transmission off period is effected by commanding the at least one transmission related timer to stop counting and to hold a count value present at the end of the transmission on period until the end of the transmission off period unchanged.

20. The method according to claim 14, further comprising
receiving a discontinuous operation configuration message by which the transmission on period and/or transmission off period is configured.

21. The method according to claim 20, further comprising
receiving the discontinuous operation configuration message on a shared operation channel during the transmission on period; and
receiving the discontinuous operation configuration message during an operation state and during an idle state of the network element carrying out the method.

22. (canceled)

23. The method according to claim 14, further comprising
configuring a discontinuous operation configuration message by which the on period and/or off period is configured and
sending the discontinuous operation configuration message to a network element.

24-27. (canceled)
